(19) United States
(12) Patent Application Publication
(10) Pub. No.: US 2010/0066334 A1
(43) Pub. Date: Mar. 18, 2010

(54) Softstart controller

(76) Inventor: Doris Yang, St. Zhubei City (TW)

Correspondence Address: REED SMITH LLP, Suite 1400, 3110 Fairview Park Drive, Falls Church, VA, 22042, US

(21) Appl. No.: 12/232,291

(22) Filed: Sep. 15, 2008

(51) Int. Cl. G05F 1/618

(52) U.S. Cl. 323/283

(57) ABSTRACT

According to the invention, a DC-DC converter with a digital softstart controller comprises a feedback voltage; a reference voltage; an error amplifier; and a PWM comparator. The error amplifier compares the reference voltage with the feedback voltage. The error amplifier is coupled to the digital softstart controller. The PWM comparator compares signal from the error amplifier. Wherein, the digital softstart controller contains a mapping table, which has information regarding voltage step and time step so as to provide an arbitrary voltage.

### FIELD OF THE INVENTION

The present invention relates generally to a softstart technique for a DC-DC converter, and more particularly to a softstart controller that applies to every DC-DC converter based on the requirement of the system.

### DESCRIPTION OF PRIOR ART

DC-DC switching converter converts one level of electrical energy into another level of electrical energy at the load by switching. The key function of DC-DC power management IC is the controlling of the switch

The conventional DC-DC converter comprises a reference voltage 10, an error amplifier 20 and a PWM comparator 30. The error amplifier 20 compares the reference voltage 10 with the feedback voltage from the FB pin. The PWM comparator 30 compares the signal from the error amplifier with the ramp wave or the current sensed signal. And the output of PWM comparator 30 controls the states of switch finally.

The error amplifier 20 compares the reference voltage with the FB pin voltage. When the feedback voltage is lower than the reference voltage, the output voltage of the error amplifier 20 increases.

FIG. 1 shows the error amplifier of the conventional DC-DC converter. The output voltage VOUT is divided by the resistors and then is compared with a reference voltage. Normally, the output voltage VOUT should be equal to zero during startup, thus the output is increased rapidly once the power is ON. This acute change always causes the overshot on the output. In order to get the moderate increasing of output, system designers are making painstaking efforts on it. Under the great development, the concept of softstart is appeared. And it becomes the important features of power management IC.

Up to now, there are two main methods to perform “softstart”. One is in analog way, another is in digital way. Actually a capacitor is always be used in analog circuitry, the charging time of this capacitor can be treated as softstart time. FIG. 2 shows the error amplifier with the capacitor. The error amplifier 20 requires the capacitor 40 to adjust the response time of the error amplifier 20.

However, the analog soft start controller is not accurate because of the variation of the capacitance. Besides, the capacitor 40 is too large to be integrated in a chip. It is difficult to implement a large capacitor 40 inside the chip.

Digital software is more and more popular. FIG. 3 shows the digital soft start controller. It involves a counter 50 and a digital to analog converter (DAC) 60. The two more building blocks may provide more stable performance. The counter 50 is mainly used to count the softstart time and give reference to the DAC 60. The DAC 60 contains a mapping table. When the system is powered up, the DC-DC converter is in the softstart period, SW1 is OFF and SW2 is ON. The feedback signal is compared with the output of the DAC 60. When the softstart is finished, SW1 is ON and SW2 is OFF.

FIG. 4 shows a mapping table of FIG.3. The time step of the counter 50 and the voltage step of the DAC 60 are designed as a constant. Thus the voltage reference which provided by counter 50 and DAC 60 are increased in constant voltage step under the constant time step. However this may not be suitable in several systems.

### SUMMARY OF THE INVENTION

The present invention provides a softstart controller for a DC-DC converter to resolve the foregoing problems faced by the conventional softstart controller.

An object of the present invention is to provide a DC-DC converter and a digital softstart controller.

In accordance with an aspect of the present invention, a DC-DC converter with a digital softstart controller comprises a feedback voltage; a reference voltage; an error amplifier; and a PWM comparator. The error amplifier compares the reference voltage with the feedback voltage. The error amplifier is coupled to the digital softstart controller. The PWM comparator compares signal from the error amplifier. Wherein, the digital softstart controller contains a mapping table, which has information regarding voltage step and time step so as to provide an arbitrary voltage.

In the preferred embodiment of the invention, an output voltage is divided by resistors, that divided voltage is then compared with a reference voltage. The PWM comparator compares the signal from the error amplifier with a ramp wave in voltage mode DC-DC converter. On the other hand, the PWM comparator compares the signal from the error amplifier with a current sensed signal in current mode DC-DC converter. The output of the PWM comparator controls the states of a power MOS. If the feedback voltage is lower than the reference voltage, the output voltage of the error amplifier increases. The digital softstart controller comprises a counter and a digital to analog converter (DAC). The counter counts the softstart time and gives reference to the DAC. The feedback signal is compared with the output of the DAC in the softstart period. The time step of the counter is variable. The voltage step of the DAC is variable.

A larger step is preferred during the starting of the softstart, a smaller step is preferred at the later softstart period.

In accordance with another aspect of the present invention, a digital softstart controller comprises a feedback voltage; a reference voltage; an error amplifier; and a mapping table. The error amplifier compares the reference voltage with the feedback voltage. The mapping table has information regarding voltage step and time step so as to provide an arbitrary voltage.

In the preferred embodiment of the invention, the digital softstart controller further comprises a counter. The counter counts the softstart time and gives reference to the mapping table. a time step of the counter is variable. a voltage step of the mapping table is variable.

The present invention may best be understood through the following description with reference to the accompanying drawings, in which:

### BRIEF DESCRIPTION OF THE DRAWINGS

FIG. 1 shows error amplifier of conventional DC-DC converter.

FIG. 2 shows error amplifier with capacitor.

FIG. 3 shows conventional digital soft start controller.

FIG. 4 shows a mapping table of FIG. 3.

FIG. 5 shows a digital soft start controller of a preferred embodiment according to the present invention.

FIG. 6 shows a mapping table of FIG. 5.

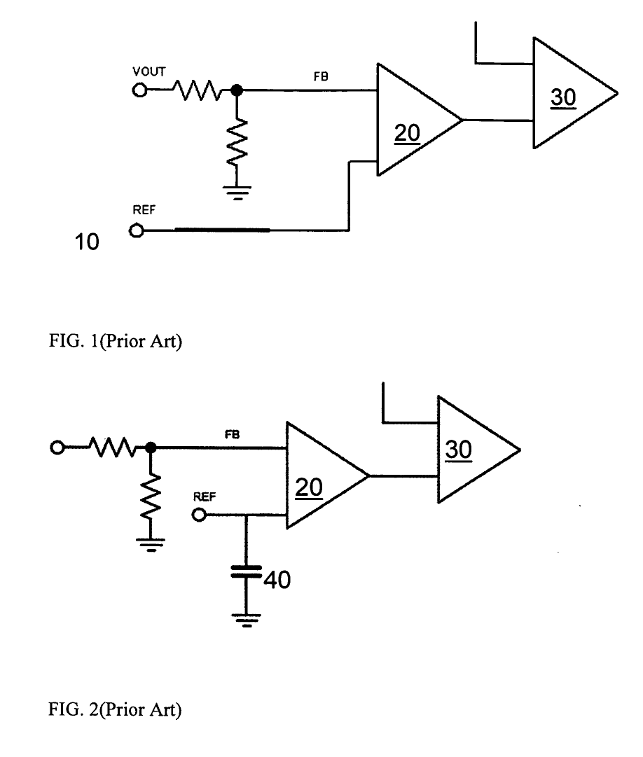

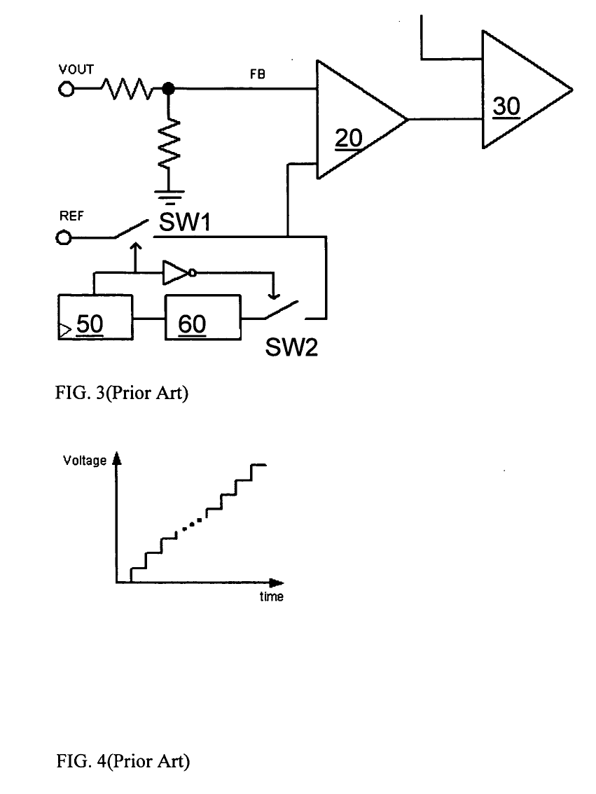

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

According to the preferred embodiment of the present invention, a DC-DC converter with a digital softstart controller comprises a feedback voltage; a reference voltage; an error amplifier; and a PWM comparator. The error amplifier compares the reference voltage with the feedback voltage. The error amplifier is coupled to the digital softstart controller. The PWM comparator compares signal from the error amplifier. Wherein, the digital softstart controller contains a mapping table, which has information regarding voltage step and time step so as to provide an arbitrary voltage.

An output voltage is divided by resistors. The output voltage is compared with a reference voltage. The PWM comparator compares the signal from the error amplifier with a ramp wave in voltage mode DC-DC converter. The PWM comparator compares the signal from the error amplifier with a current sensed signal in current mode DC-DC converter. The output of the PWM comparator controls the states of a power MOS. If the feedback voltage is lower than the reference voltage, the output voltage of the error amplifier 20 increases. The digital softstart controller comprises a counter and a digital to analog converter (DAC). The counter counts the softstart time and gives reference to the DAC.

The feedback signal is compared with the output of the DAC in the softstart period. The time step of the counter is variable. The voltage step of the DAC is variable. A larger step is preferred during the starting of the softstart. A smaller step is preferred at the later softstart period.

According to another preferred embodiment of the present invention, a digital softstart controller comprises a feedback voltage; a reference voltage; an error amplifier; and a mapping table. The error amplifier compares the reference voltage with the feedback voltage. The mapping table has information regarding voltage step and time step so as to provide an arbitrary voltage.

The digital softstart controller further comprises a counter. The counter counts the softstart time and gives reference to the mapping table. a time step of the counter is variable. a voltage step of the mapping table is variable.

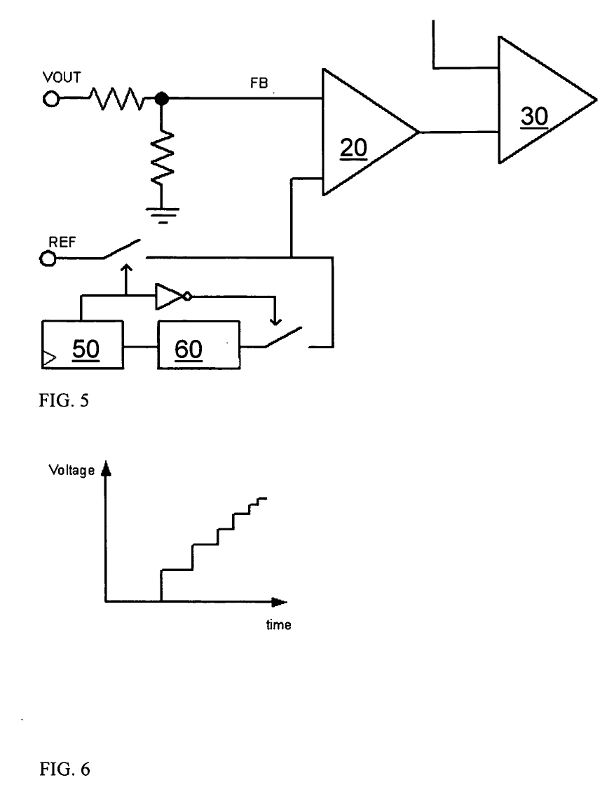

FIG. 5 shows a digital soft start controller of a preferred embodiment according to the present invention. The digital soft start controller of the present invention modifies voltage and time steps. The digital soft start controller includes at least an error amplifier 20, a counter 50 and a DAC 60.

Each time a pulse occurs on count input, the digital value stored in the counter 50 increases by 1. The counter 50 counts the softstart time and give reference to the DAC 60. The DAC 60 contains a mapping table. When the system is powered up, the DC-DC converter is in the softstart period, SW1 is OFF and SW2 is ON. The feedback signal is compared with the output of the DAC 60. When the softstart is finished, SW1 is ON and SW2 is OFF.

FIG. 6 shows a mapping table of FIG. 5. During the starting of the softstart, a larger step is preferred since the output could increase faster without ripple. And a smaller step is preferred at the later softstart period in order to avoid overshot. The DAC 60 may be treated as a mapping table, which can provide an arbitrary voltage. If we could distribute the steps properly, we could optimize the number of bit of mapping table. Besides that, the mapping table of the DAC 60 can be easily amended based on the requirement of the system.

By amending the mapping table, the reference voltage to the error amplifier can be easily changed. Thus softstart time is more accurate accordingly. The variable mapping table may be used for different system. The presently described softstart controller, thus, serves demands much more adequately.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A DC-DC converter with a digital softstart controller, comprising:
a feedback voltage;
a reference voltage;
an error amplifier comparing the reference voltage with the feedback voltage, the error amplifier coupled to the digital softstart controller; and
a PWM comparator for comparing signal from the error amplifier;
wherein, the digital softstart controller contains a mapping table, which has information regarding voltage step and time step so as to provide an arbitrary voltage.

2. The DC-DC converter according to claim 1, wherein an output voltage is divided by resistors.

3. The DC-DC converter according to claim 2, wherein the divided voltage is compared with a reference voltage.

4. The DC-DC converter according to claim 1, wherein the PWM comparator compares the signal from the error amplifier with a ramp wave.

5. The DC-DC converter according to claim 1, wherein the PWM comparator compares the signal from the error amplifier with a current sensed signal.

6. The DC-DC converter according to claim 1, wherein the output of the PWM comparator controls the states of a power MOS.

7. The DC-DC converter according to claim 1, wherein the feedback voltage is lower than the reference voltage.

8. The DC-DC converter according to claim 7, wherein the output voltage of the error amplifier increases.

9. The DC-DC converter according to claim 1, wherein the digital softstart controller comprises a counter and a digital to analog converter (DAC).

10. The DC-DC converter according to claim 9, wherein the counter counts the softstart time and gives reference to the DAC.

11. The DC-DC converter according to claim 10, wherein the feedback signal is compared with the output of the DAC in the softstart period.

12. The DC-DC converter according to claim 9, wherein the time step of the counter is variable.

13. The DC-DC converter according to claim 9, wherein the voltage step of the DAC is variable.

14. The DC-DC converter according to claim 9, wherein a larger step is preferred during the starting of the softstart.

15. The DC-DC converter according to claim 9, wherein a smaller step is preferred at the later softstart period.

16. A digital softstart controller comprising:
a feedback voltage;
a reference voltage;
an error amplifier comparing the reference voltage with the feedback voltage; and
a mapping table having information regarding voltage step and time step so as to provide an arbitrary voltage.

17. The digital softstart controller according to claim 16, further comprising a counter.

18. The digital softstart controller according to claim 17, wherein the counter counts the softstart time and gives reference to the mapping table.

19. The digital softstart controller according to claim 18, wherein a time step of the counter is variable.

20. The digital softstart controller according to claim 16, wherein a voltage step of the mapping table is variable.
